(19) United States
(12) Patent Application Publication
(10) Pub. No.: US 2004/0254085 A1
(43) Pub. Date: Dec. 16, 2004

(54) [HIGH CAUSTIC CONTACT CLEANER]

(75) Inventors: Carol Anne Rouillard, Loveland, OH (US); Kenneth J. Roach, Hamilton, OH (US)

Correspondence Address: S.C. JOHNSON COMMERCIAL MARKETS INC, 8310 16TH STREET, M/S 510, PO BOX 902, STURTEVANT, WI, 53177-0902, US

(73) Assignee: JOHNSONDIVERSEY, INC., Sturtevant, WI (US)

(21) Appl. No.: 10/249,921

(22) Filed: May 19, 2003

(51) Int. Cl. C11D 17/00

(52) U.S. Cl. 510/433

(57) ABSTRACT

A cleaning formulation especially suited for cleaning a substantially vertical or inclined surfaces which is soiled by components used in the food or beverage industry. The cleaning formulation has foam characteristics as well as long cling times. Yet, it is easily rinsed from the surface.

### BACKGROUND OF INVENTION

1. Technical Field

This invention relates to a highly alkaline foam cleaning formulation. More particularly, it relates to a foam cleaning formulation wherein the caustic content is at least 20% wt. and is capable of being retained on a vertical wall surface 5-7 times longer than a standard foam cleaner.

2. Background Art

Cleaning formulations which are especially formulated for cleaning vertical or inclined hard surfaces are known. For example, see U.S. Pat. No. 5,906,973.

Thickened aqueous compositions are described in U.S. patent application publication No. 2002/0082178 A1. The maximum amount of caustic material is 10%. U.S. Pat. No. 6,402,891 discloses 25% caustic and mentions spraying cleaning compositions.

U.S. Pat. No. 3,668,153 discloses a powder foam cleaning composition containing 10-90% alkali metal hydroxide.

Concentrated or thickened cleaning compositions are disclosed in U.S. Pat. Nos. 6,150,320 and 5,705,467. No disclosure of alkalinity is made.

The prior art does not provide a caustic cleaner containing 20% and above caustic in a foam cleaning product which has good vertical cling and easy rinsing. Such a formulation is advantageous in cleaning hard surface walls in an industrial food processing plant.

The objects of the invention therefore are:a)Providing an improved caustic cleaning composition.

b)Providing an improved liquid caustic cleaning composition in the form of a foam.

c)Providing an improved liquid caustic cleaning composition of the foregoing type which facilitates good vertical cling.

d)Providing an improved caustic cleaning composition of the foregoing type which has easy rinsing.

e)Providing an improved liquid caustic cleaning composition of the foregoing type which is economical to manufacture.

f)Providing an improved liquid caustic cleaning composition of the foregoing type which can be applied with standard application equipment.

### SUMMARY OF INVENTION

The foregoing objects are accomplished and the shortcomings of the prior art are overcome by the cleaning formulation of the invention which is adapted for use in cleaning a substantially vertical or an inclined surface. In one embodiment the formulation includes:a)at least 20% wt. of an alkali;b)an amine oxide;c)at least one anionic surfactant; andd)waterln a preferred embodiment, the alkali is sodium hydroxide, the amine oxide is bis(2-hydroxyethyl) tallow amine oxide, the anionic surfactant is a mixture of sodium lauryl diethoxy ether sulphate and sodium lauryl sarcosinate.

In another preferred embodiment, the sodium hydroxide is present in an amount of 25 to 35% wt., the bis(2-hydroxyethyl) tallow amine is present in an amount of 0.5 to 8.0% wt. and the anionic surfactant is present in an amount of 0.3 to 5.0% wt.

In one aspect, the formulation further includes nonionic surfactants as well as amphoteric surfactants.

In still another aspect, the formulation further includes hydrotopes and solvents.

In yet another aspect, the formulation can be diluted in water at the rate of 1 part of formulation to 10 to 50 parts water.

These and still other objects and advantages of the invention will be apparent from the description which follows. In the detailed description below, preferred embodiments of the invention will be described in reference to the full scope of the invention. Rather, the invention may be employed in other embodiments.

### DETAILED DESCRIPTION

In the following examples, the materials are combined in the order indicated in the following Examples. Sufficient agitation is provided to assure each material is dissolved before the next is added.

### EXAMPLE 1

| Material | Wt % |
|---|---|
| water | 12.0 |
| aminotri(methylenephosphonic acid) - 50% solution | 1 |
| sodium hydroxide - 50% solution | 70 |
| bis(2-hydroxyethyl) tallow amine oxide - 40% solution | 6.75 |
| sodium lauryl diethoxy ether sulphate - 30% solution | 4.75 |
| sodium dodecylbenzene sulphonate | 1 |
| alkyl polyglucoside - 50% solution | 4.5 |

### EXAMPLE 2

| Material | Wt % |
|---|---|
| water | 12 |
| aminotri(methylenephosphonic acid) - 50% solution | 1 |
| sodium hydroxide - 50% solution | 70 |
| bis(2-hydroxyethyl) tallow amine oxide - 40% solution | 7 |
| sodium lauryl diethoxy ether sulphate - 30% solution | 5 |
| linear alkylbenzene sulphonic acid | 1 |
| potassium salt of phosphonate ester | 1 |
| sodium cocoamphodipropionate - 37% solution | 3 |

### EXAMPLE 3

| Material | Wt % |
|---|---|
| water | 12.75 |
| aminotri(methylenephosphonic acid) - 50% solution | 1 |
| sodium hydroxide - 50% solution | 70 |
| bis(2-hydroxyethyl) tallow amine oxide - 40% solution | 6.75 |
| sodium lauryl diethoxy ether sulphate - 30% solution | 5 |
| linear alkylbenzene sulphonic acid | 1 |
| polyoxyethylene 20 sorbitan monooleate | 1 |
| sodium xylene sulphonate - 40% solution | 2 |
| potassium salt of phosphonate ester | 0.5 |

### EXAMPLE 4

| Material | Wt % |
|---|---|
| water | 11.75 |
| aminotri(methylenephosphonic acid) - 50% solution | 1 |
| sodium hydroxide - 50% solution | 70 |
| bis(2-hydroxyethyl) tallow amine oxide - 40% solution | 6.75 |
| sodium lauryl diethoxy ether sulphate - 30% solution | 5 |
| linear alkylbenzene sulphonic acid | 1 |
| aliphatic phosphate ester | 4.5 |

### EXAMPLE 5

| Material | Wt % |
|---|---|
| water | 25 |
| aminotri(methylenephosphonic acid) - 50% solution | 1 |
| sodium hydroxide - 50% solution | 60 |
| bis(2-hydroxyethyl) tallow amine oxide - 40% solution | 6 |
| sodium secondary alkane sulphonate - 60% solution | 3 |
| sodium lauroyl sarcosinate - 30% solution | 2 |
| propylene glycol | 3 |

### EXAMPLE 6

| Material | Wt % |
|---|---|
| water | 19.5 |
| aminotri(methylenephosphonic acid) - 50% solution | 1 |
| sodium hydroxide - 50% solution | 70 |
| bis(2-hydroxyethyl) tallow amine oxide - 40% solution | 5 |
| sodium lauryl diethoxy ether sulphate - 30% solution | 3 |
| sodium lauroyl sarcosinate - 30% solution | 1.5 |

### EXAMPLE 7

| Material | Wt % |
|---|---|
| water | 13.75 |
| aminotri(methylenephosphonic acid) - 50% solution | 1 |
| sodium hydroxide - 50% solution | 70 |
| bis(2-hydroxyethyl) tallow amine oxide - 40% solution | 6.75 |
| sodium lauryl diethoxy ether sulphate - 30% solution | 4 |
| sodium lauroyl sarcosinate - 30% solution | 1 |
| propylene glycol | 2 |
| propylene glycol mono methyl ether | 1.5 |

### EXAMPLE 8

| Material | Wt % |
|---|---|
| water | 20 |
| aminotri(methylenephosphonic acid) - 50% solution | 1 |
| sodium hydroxide - 50% solution | 45 |
| potassium hydroxide - 40% solution | 20 |
| bis(2-hydroxyethyl) tallow amine oxide - 40% solution | 6.5 |
| sodium lauryl diethoxy ether sulphate - 30% solution | 3 |
| sodium lauroyl sarcosinate - 30% solution | 1 |
| propylene glycol | 2 |
| propylene glycol mono methyl ether | 1.5 |

### EXAMPLE 9

| Material | Wt % |
|---|---|
| water | 30.75 |
| aminotri(methylenephosphonic acid) - 50% solution | 1 |
| sodium hydroxide - 50% solution | 40 |
| EDTA - 40% solution | 7.5 |
| bis(2-hydroxyethyl) tallow amine oxide - 40% solution | 7 |
| sodium lauryl diethoxy ether sulphate - 30% solution | 6 |
| potassium salt of phosphonate ester¹ | 5 |
| propylene glycol | 2 |
| propylene glycol mono methyl ether | 0.75 |

The above composition is a homogeneous liquid that, when educted and diluted to give a 5% wt. solution through a foamer and sprayed on a vertical surface, gives a foam that remains on the surface for at least 8-10 minutes. In use, the product is different in appearance than a typical form or gel. It forms a thin (foam-like) layer that clings to vertical surfaces 5-7 times longer than a standard foam cleaner.

The cleaning formulation of the invention is operable With any spray cleaning operations where high soil loads are encountered. It is especially suitable for Open Plant Cleaning in the food and beverage industry where saponifiable soils (such as animal fats and vegetable oils), and carbonized soils are commonly encountered.

Alkalis

Sodium hydroxide is utilized in the foregoing examples as an alkali. Other alkalis can be employed in the formulation such as potassium hydroxide, monoethanolamine, diethanolamine, triethanolamine or mixtures thereof.

Chelants

Aminotri (methylenephosphonic acid) is specified in the examples as a chelant. Other chelants which can be employed include EDTA, NTA, sodium or potassium polyphosphate, 1-hydroxyethylidene-1,1-diphosphonic acid, sodium gluconate and any other water softening agents.

Hydrotropes

Phosphate esters are employed in the examples as hydrotrope. Other hydrotropes can be employed include sodium xylene sulphonate and sodium cumene sulphonate.

Amine Oxides

Bis(2-hydroxyethyl) tallow amine oxide is a preferred amine oxide. However, other amine oxides or combination of amine oxides which provide effective vertical cling would be acceptable alternatives in the composition.

Surfactants

Certain anionic surfactants are utilized in the examples such as sodium lauryl diethoxy ether sulphate, linear alkylbensene sulphonic acid, sodium lauroyl sarcosinate. Others which can be employed are alkyl benzene sulfonates, an alkyl sulfonates, an alkyl ether sulfates, an alpha alefin sulfonates, an alkyl sarcosinates and mixtures thereof.

Alkyl polyglucoside is exemplified as a nonionic surfactant. Others which can be utilized include ethoxylated sorbitan monooleates and ethoxylated sorbitan monostearates.

An amphoteric surfactant is specified in the examples as sodium cocoamphodipropionate. Others which can be used include amphoacetates and amphodiacetates.

Solvents

Propylene glycol and propylene glycol mono methyl ether are preferred solvents as shown in the examples. Others which can be employed include dipropylene glycol, diethylene glycol mono ethyl ether, dipropylene glycol mono methyl ether and other low molecular weight glycols and glycol ethers.

While a dilution rate of 1 part of the formulation to 50 parts of water has been previously indicated, a preferred rate is 1 to 20, respectively.

It will thus be seen that there is now provided a cleaning formulation which affords improved cleaning while maintaining a residual foam level. While certain embodiments are disclosed, others can be employed provided they meet the performance qualifications as set forth herein. Other variations and modifications of this invention will be obvious to those skilled in this art. This invention is not to be limited as set forth in the following claims.

Industrial Applicability

The formulations of this invention are useful in cleaning a substantially vertical or inclined surface which is soiled with food or beverage components. They provide a high degree of cleaning efficiency with foam retention.

1. A dilutable cleaning formulation for cleaning a substantially vertical or an inclined surface comprising:
a)at least 20% wt. of an alkali;
b)an amine oxide;
c)at least one anionic surfactants; and
d)water

2. The cleaning formulation defined in claim 1 wherein the cleaning formulation is diluted at a ratio of 1 part formulation to between 10 and 50 parts water.

3. The cleaning formulation defined in claim 2 wherein the cleaning formulation is diluted at a ratio of about 1 part formulation to 20 parts water.

4. The cleaning formulation as defined in claim 1 wherein the alkali is at least one alkali metal hydroxide.

5. The cleaning formula as defined in claim 1 wherein the alkali is an alkali metal hydroxide selected from the group consisting of sodium hydroxide, potassium hydroxide and a mixture thereof.

6. The cleaning formula as defined in claim 5 wherein the alkali metal hydroxide is sodium hydroxide.

7. The cleaning formulation as defined in claim 6 wherein the sodium hydroxide is present in the range of about 25-35% wt. as active NaOH.

8. The cleaning formulation as defined in claim 1 wherein the amine oxide is present in the range of about 0.5-8.0% as active.

9. The cleaning formulation as defined in claim 8 wherein the amine oxide is bis(2-hydroxyethyl) alkylamine oxide.

10. The cleaning formulations as defined in claim 9 wherein the amine oxide is bis(2-hydroxyethyl) tallow amine oxide.

11. The cleaning formulation as defined in claim 1 wherein the anionic surfactant is present in the range of about 0.3-5.0% as active.

12. The cleaning formulation as defined in claim 11 wherein the anionic surfactant(s) is selected from the group consisting of an alkyl benzene sulfonate, an alkyl sulfonate, an alkyl ether sulfate, an alpha olefin sulfonate, and an alkyl sarcosinate.

13. The cleaning formulation as defined in claim 1 wherein the alkali is present in the amount of 25% wt.

14. The cleaning formulation as defined in claim 12 wherein the surfactant is a mixture of the alkyl ether sulfate and alkyl sarcosinate.

15. The cleaning formulation as defined in claim 14 wherein the alkyl ether sulfate is a sodium lauryl diethoxy ether sulfate and the alkyl sarcosinate is sodium lauroyl sarcosinate.

16. The cleaning formulation as defined in claim 12 wherein the anionic surfactant is a mixture of alkyl sulfonate and alkyl sarcosinate.

17. The cleaning formulation as defined in claim 16 wherein the alkyl sulfonate is a secondary alkane sulfonate and the alkyl sarcosinate is sodium lauroyl sarcosinate.

18. The cleaning formulation as defined in claim 12 wherein the anionic surfactant is lauryl ether sulfate.

19. The cleaning formulation as defined in claim 1 further including water conditioning agents, hydrotroping agents. (The formulation may also contain materials used to enhance processing of the formulation itself.)

20. The cleaning formulation as defined in claim 19 diluated at a ratio of about 1 part product to 10 to 50 parts water, the alkali is sodium hydroxide, the amine oxide is bis (2-hydroxylethyl) tallow amine oxide and the anionic surfactant blend is a mixture of sodium lauryl diethoxy ether sulfate and sodium lauroyl sarcosinate.

21. The cleaning formulation as defined in claim 20 further including a water conditioning agent.

22. The cleaning formulation as defined in claim 21 wherein the water conditioning agent is aminotri(methylenephosphonic acid).

23. The cleaning formulation as defined in claim 20 further including hydrotroping agent.

24. The cleaning formulation as defined in claim 23 wherein the hydrotroping agent is a phosphate ester.

25. The cleaning formulation as defined in claim 23 wherein the hydrotroping agent is selected from the group consisting of a glycol, a glycol ether solvent, and a mixture thereof.

26. The cleaning formulation as defined in claim 20 further including surface active agents.

27. The cleaning formulation as defined in claim 26 wherein the surface active agents are selected from groups consisting of nonionic and amphoteric surfactants.

28. The cleaning formulation as defined in claim 26 wherein the surface active agent is a sorbitan ester.

29. The cleaning formulation as defined in claim 26 wherein the surface active agent is an alkylpolyglucoside.

30. The cleaning formulation as defined in claim 20 wherein the water conditioning agent is aminotri(methylenephosphonic acid) and the hydrotroping agent is a mixture of propylene glycol and glycol ether solvent.
